(19) United States
(12) Patent Application Publication
(10) Pub. No.: US 2015/0046018 A1
(43) Pub. Date: Feb. 12, 2015

(54) AUTONOMOUS MOVING BODY, OBSTACLE SENSING METHOD, AND OBSTACLE AVOIDING METHOD

(71) Applicant: TOYOTA JIDOSHA KABUSHIKI KAISHA, Toyota-shi (JP)

(72) Inventors: Hironao HAYASHI, Motosu-gun (JP); Takuya IWATA, Toyota-shi (JP)

(21) Appl. No.: 14/454,995

(22) Filed: Aug. 8, 2014

(30) Foreign Application Priority Data
Aug. 9, 2013 (JP) 2013-166137

(51) Int. Cl. G05D 1/02

(52) U.S. Cl. CPC G05D 1/0214; Y10S 901/01
USPC 701/26; 901/1

(57) ABSTRACT

Provided is an autonomous moving body including a recording unit that records in advance position information of a fixed obstacle whose position does not change, a detection unit that detects an obstacle likely to interfere with the autonomous moving body when moving through a moving path, a check unit that checks whether the detected obstacle is the fixed obstacle, a control unit that determines whether to clear away the obstacle when the check unit concludes that the obstacle is not the fixed obstacle, and an informing unit that outputs a signal requesting to clear away the obstacle when the control unit determines to clear away the obstacle.

### INCORPORATION BY REFERENCE

This application is based upon and claims the benefit of priority from Japanese patent application No. 2013-166137, filed on Aug. 9, 2013, the disclosure of which is incorporated herein in its entirety by reference.

### BACKGROUND OF THE INVENTION

1. Field of the Invention

The present invention relates an autonomous moving body, an obstacle sensing method, and an obstacle avoiding method.

2. Description of Related Art

An autonomous moving body such as a robot and a vehicle that moves to a destination in an autonomous manner has been proposed. In Japanese Unexamined Patent Application Publication No. 2012-022467, an autonomous moving body that takes avoiding action, stopping action or evacuation action appropriately according to situation when an obstacle that is likely to interfere with the autonomous moving body is in the way of the moving path is disclosed.

### SUMMARY OF THE INVENTION

As described above, the autonomous moving body according to the related art can appropriately take avoiding action or the like according to situation. However, the autonomous moving body takes avoiding action and the like even when there is an obstacle that is temporarily placed on the moving path and can be easily cleared away by a person, which degrades the moving efficiency of the autonomous moving body. This poses as a significant problem when the autonomous moving body moves along the path where the position of an obstacle that can be cleared away changes frequently. For example, the position of an obstacle that is relatively light-weight and can be easily cleared away such as a bag or a chair can change every time, and the moving efficiency of the autonomous moving body is significantly degraded if the autonomous moving body takes avoiding action or the like each time.

The present invention has been accomplished to solve the above problems and an object of the present invention is thus to provide an autonomous moving body, an obstacle sensing method, and an obstacle avoiding method with no degradation of the moving efficiency.

An autonomous moving body according to an embodiment of the invention includes a recording unit that records in advance position information of a fixed obstacle whose position does not change, a detection unit that detects an obstacle likely to interfere with the autonomous moving body when moving through a moving path, a check unit that checks whether the detected obstacle is the fixed obstacle, a control unit that determines whether to clear away the obstacle when the check unit concludes that the obstacle is not the fixed obstacle, and an informing unit that outputs a signal requesting to clear away the obstacle when the control unit determines to clear away the obstacle. In this structure, it is possible to prevent the degradation of the moving efficiency of the autonomous moving body even when the autonomous moving body moves through the path where the position of the obstacle changes frequently.

Further, in the autonomous moving body according to an embodiment of the invention, it is preferred that the detection unit detects an obstacle around the moving path at each of a plurality of times when the autonomous moving body moves through the moving path, and when the detected obstacle is an obstacle whose position does not change, position information of the detected obstacle is recorded as position information of the fixed obstacle in the recording unit. In this structure, it is possible to easily prevent the degradation of the moving efficiency of the autonomous moving body without need for a person to enter information of the fixed obstacle.

Further, in the autonomous moving body according to an embodiment of the invention, it is preferred that when the check unit concludes that the obstacle is not the fixed obstacle, the control unit determines whether the obstacle is avoidable, and when determining that the obstacle is avoidable, the control unit controls the autonomous moving body to move to avoid the obstacle, and when determining that the obstacle is not avoidable, the control unit controls the informing unit to output the signal. In this structure, it is possible to reduce the time required for waiting action and prevent the degradation of the moving efficiency of the autonomous moving body.

Further, in the autonomous moving body according to an embodiment of the invention, it is preferred that when a specified period of time has elapsed with the obstacle remaining without being cleared away after the signal is output, the control unit controls the autonomous moving body to detect a person nearby, and when a person nearby is detected, the control unit controls the autonomous moving body to move toward the person and controls the informing unit to output the signal again, and when a person nearby is not detected, the control unit controls the autonomous moving body to detour around the obstacle. In this structure, it is possible to reduce the time required for waiting action and prevent the degradation of the moving efficiency of the autonomous moving body.

Further, it is preferred that the autonomous moving body according to an embodiment of the invention is to provide a service to persons around the moving path, and the control unit accesses a schedule management system and checks schedules of the persons to receive the service, calculates an attendance rate for each organization or group to which the persons belong, and changes the moving path to omit the service to the persons belonging to the organization or group where the attendance rate is less than a specified value. In this structure, it is possible to limit the moving path and prevent the degradation of the moving efficiency of the autonomous moving body.

Further, it is preferred that the autonomous moving body according to an embodiment of the invention is to provide a service to persons around the moving path, and the control unit calculates an attendance rate of the persons to receive the service for each area by using a senor, and changes the moving path to omit the service to the persons belonging to the area where the attendance rate is less than a specified value. In this structure, it is possible to limit the moving path and prevent the degradation of the moving efficiency of the autonomous moving body.

An obstacle sensing method for an autonomous moving body according to an embodiment of the invention includes a recording step of recording in advance position information of a fixed obstacle whose position does not change, a detection step of detecting an obstacle likely to interfere with the autonomous moving body when moving through a moving path, a check step of checking whether the detected obstacle is the fixed obstacle, and a determination step of determining that the obstacle is a movable obstacle whose position changes or a movable obstacle placed temporarily when the obstacle is not the fixed obstacle. It is thereby possible to prevent the degradation of the moving efficiency of the autonomous moving body.

Further, in the obstacle sensing method for an autonomous moving body according to an embodiment of the invention, it is preferred that the recording step includes a peripheral detection step of detecting an obstacle around the moving path at each of a plurality of times when the autonomous moving body moves through the moving path, and a fixed obstacle recording step of recording position information of the obstacle detected in the peripheral detection step and whose position does not change as position information of the fixed obstacle. It is thereby possible to easily prevent the degradation of the moving efficiency of the autonomous moving body without need for a person to enter information of the fixed obstacle.

Further, an obstacle avoiding method for an autonomous moving body according to an embodiment of the invention includes an obstacle determination step of determining that the obstacle likely to interfere with the autonomous moving body as the movable obstacle by using the obstacle sensing method for an autonomous moving body described above, an avoidance determination step of determining whether the movable obstacle is avoidable, an avoiding step of moving to avoid the movable obstacle when determining that the movable obstacle is avoidable, and a signal output step of outputting a signal requesting to clear away the movable obstacle when determining that the movable obstacle is not avoidable. It is thereby possible to prevent the degradation of the moving efficiency of the autonomous moving body.

According to the present invention, it is possible to provide an autonomous moving body, an obstacle sensing method, and an obstacle avoiding method with no degradation of the moving efficiency.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a diagram showing the positions of an autonomous moving body according to a first embodiment, a fixed obstacle and a movable obstacle within a moving area 12;

FIG. 2 is a block diagram showing a structure of a robot 11, which is the autonomous moving body according to the first embodiment;

FIG. 3 is a diagram showing an example of informing action taken by the robot 11 according to the first embodiment;

FIG. 4 is a flowchart showing a procedure of an obstacle handling process performed by the robot 11 according to the first embodiment;

FIG. 5 is a diagram showing a relationship between a robot 11, which is an autonomous moving body according to a second embodiment, and a schedule management system 51;

FIG. 6 is a flowchart showing a procedure of a schedule checking process performed by the robot 11 according to the second embodiment; and

FIG. 7 is a flowchart showing a procedure of a presence checking process performed by a robot 11, which is an autonomous moving body according to a third embodiment.

### DESCRIPTION OF THE EXEMPLARY EMBODIMENT

### First Embodiment of the Invention

According to an autonomous moving body of a first embodiment, when an obstacle whose position changes frequently or an obstacle that is temporarily placed and not usually present is in the way of the moving path and is likely to interfere with the autonomous moving body, the autonomous moving body informs that the obstacle needs to be cleared away, has the obstacle cleared away by a person around or nearby and then moves through the moving path, thereby enhancing the moving efficiency.

A first embodiment of the present invention is described hereinafter with reference to the drawings.

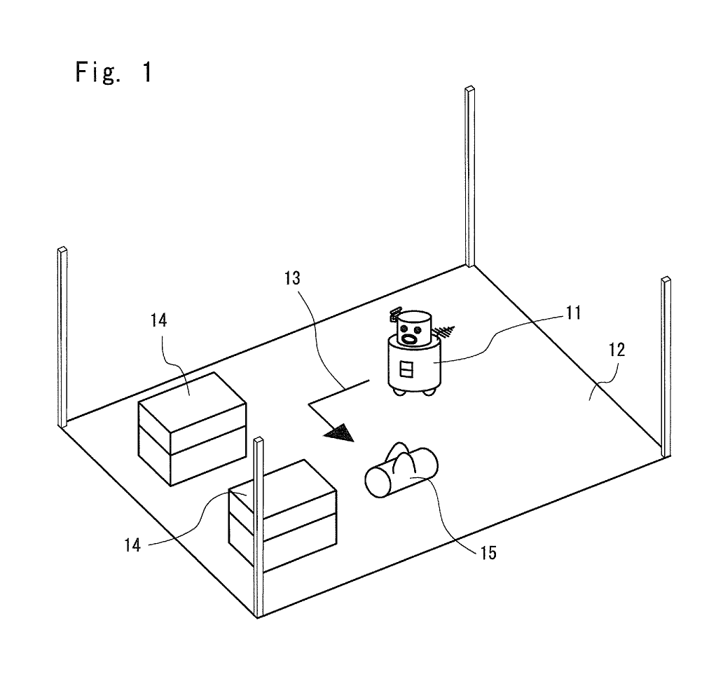

FIG. 1 is a diagram showing the positions of an autonomous moving body according to the first embodiment, a fixed obstacle and a movable obstacle within a moving area 12. The moving area 12 is an area of a specific range in an office, a factory, a store and the like, for example. A robot 11, which is the autonomous moving body, moves within the moving area 12 along a moving path 13. A desk 14, which is a fixed obstacle, exists along the moving path 13. Further, a bag 15, which is a movable obstacle, exists on the moving path 13. The bag 15 is an obstacle that is likely to interfere with the robot 11.

The fixed obstacle is a universal obstacle that is placed at all times, such as a wall, a post, a shelf and a desk, for example. The movable obstacle is a displaceable obstacle whose position changes frequently or an obstacle that is temporarily placed and not usually present, such as a chair, a bag, a baggage and a person, for example.

The robot 11 has an obstacle handling device (not shown) inside it, and moves through or around in the moving area 12 for work such as collecting dirt, delivering a paper or communicating a message, dealing with the fixed obstacle or the movable obstacle.

The moving path 13 of the robot 11 may be a fixed path or a variable path which the robot 11 creates for itself according to work. In many actual paths, such as a path between desks, the robot 11 needs to detect the fixed obstacle and the movable obstacle at every turn and move among those obstacles.

The robot 11 appropriately determines how to deal with an obstacle for each of obstacles likely to interfere with it and selects any one of avoiding action, waiting action and detouring action. The avoiding action is action that moves past an obstacle by avoiding the obstacle without going back the path it has come along. The waiting action is action that stops moving in front of an obstacle and waits. The detouring action is action that moves along a significantly modified path in order to avoid an obstacle, such as going back the path it has come along and then changing the route from the one where the obstacle exists to another one.

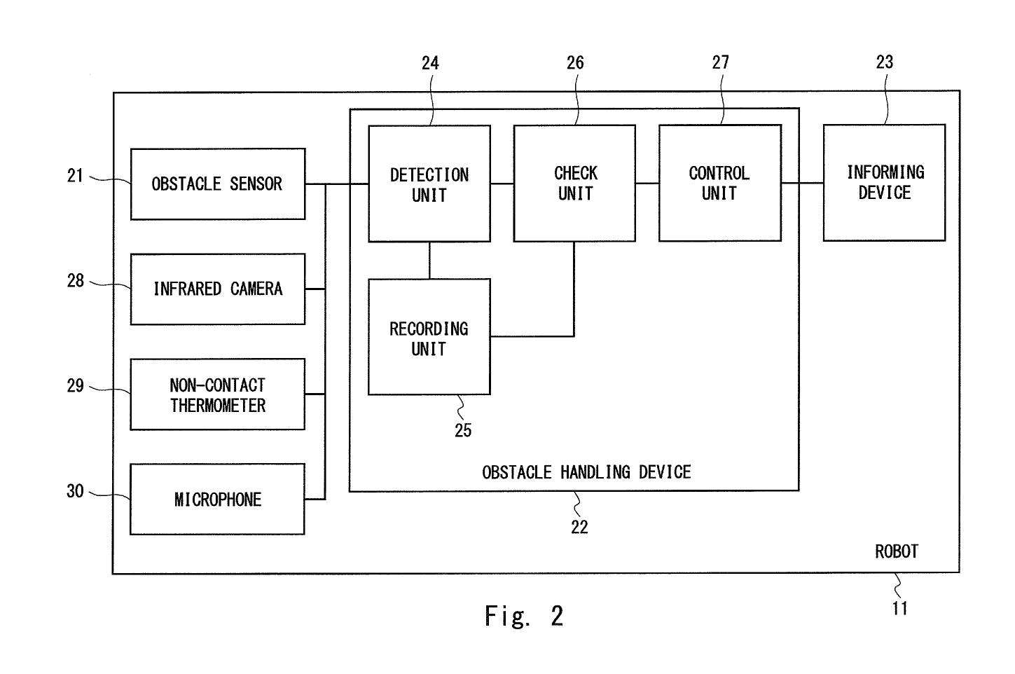

FIG. 2 is a block diagram showing the structure of the robot 11, which is the autonomous moving body according to the first embodiment.

The robot 11 includes an obstacle sensor 21, an obstacle handling device 22, an informing device 23, an infrared camera 28, a non-contact thermometer 29 and a microphone 30.

The obstacle sensor 21 is a laser rangefinder, an ultrasonic sensor, a stereo camera or the like, and outputs the distance or angle from an obstacle as obstacle information.

The obstacle handling device 22 includes a detection unit 24, a recording unit 25, a check unit 26 and a control unit 27.

The detection unit 24 detects an obstacle on the moving path 13 and an obstacle around the moving path 13 based on the obstacle information output from the obstacle sensor 21.

The recording unit 25 records position information of the obstacles detected by the detection unit 24. The recording unit 25 also records position information of obstacles that have been detected in the past. To be specific, the recording unit 25 records position information of obstacles that have been detected when the robot 11 has moved through or around in the moving area 12 in the past as well. Further, the recording unit 25 records a three-dimensional map of fixed obstacles created by comparing the obstacles detected by moving through or around in the area a plurality of times and setting an obstacle whose position does not change as a fixed obstacle.

When the detection unit 24 detects an obstacle that is likely to interfere with the robot 11 on the moving path 13, the check unit 26 checks the obstacle against the fixed obstacles recorded in the recording unit 25 for comparison. When the obstacle on the moving path 13 is not the fixed obstacle, the check unit 26 outputs a result indicating that the obstacle is the movable obstacle.

The control unit 27 controls various operations of the robot 11. The control unit 27 receives a result indicating that the obstacle on the moving path 13 is the movable obstacle from the check unit 26, and selects avoiding action or waiting action. When the control unit 27 selects waiting action, it determines the way of informing a person around or nearby about an obstacle to have it cleared away.

The informing device 23 includes an informing unit, a light, a speaker (not shown) or the like. The informing unit outputs a signal requesting to clear away the movable obstacle, and the light, the speaker, the main body of the robot 11 or the like calls a person's attention by light, sound or motion. The informing device 23 calls attention of a person around or nearby in the way determined by the control unit 27 and encourages the person to clear away the obstacle on the moving path 13.

The infrared camera 28, the non-contact thermometer 29 and the microphone 30 are to search for a person near the robot 11. Their specific operations are described later.

It should be noted that each of the elements in the obstacle handling device 22 may be implemented by executing a program by the control of an arithmetic unit (not shown) that is included in the obstacle handling device 22, which is a computer. Specifically, the obstacle handling device 22 may be implemented by loading a program that is stored in a storage unit (not shown) to a main storage device (not shown) and executing the program by the control of the arithmetic unit. Further, each of the elements is not necessarily implemented by software by a program, and it may be implemented by any combination of hardware, firm ware and software or the like.

The above-described program can be stored and provided to a computer using any type of non-transitory computer readable medium. The non-transitory computer readable medium includes any type of tangible storage medium. Examples of the non-transitory computer readable medium include a magnetic storage medium (such as a floppy disk, magnetic tape, hard disk drive, etc.), an optical magnetic storage medium (e.g. a magneto-optical disk), CD-ROM (Read Only Memory), CD-R, CD-R/W, and semiconductor memory (such as mask ROM, PROM (Programmable ROM), EPROM (Erasable PROM), flash ROM, RAM (Random Access Memory), etc.). Further, the program may be provided to a computer using any type of transitory computer readable medium. Examples of the transitory computer readable medium include electric signals, optical signals, and electromagnetic waves. The transitory computer readable medium can provide the program to a computer via a wired communication line such as an electric wire or an optical fiber or a wireless communication line.

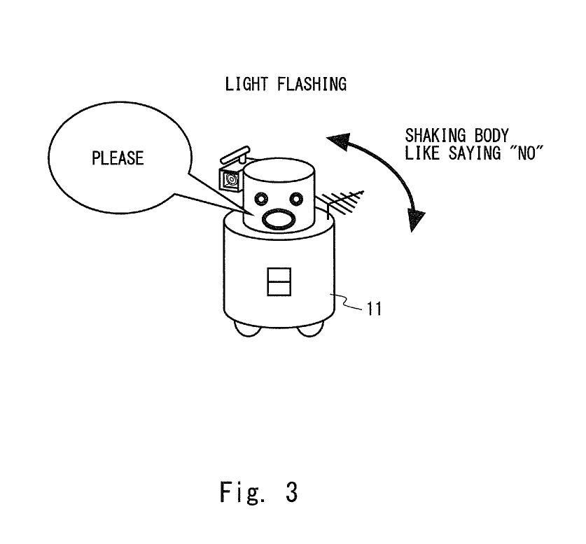

FIG. 3 is a diagram showing an example of informing action taken by the robot 11 according to the first embodiment. The robot 11 informs a person nearby that the obstacle on the moving path 13 needs to be cleared away by turning the body of the robot 11 left and right like saying “no”, by emitting a light from a revolving light, a flash lamp or the like, by making a sound saying “clear away the obstacle”, by vibrating the body of the robot 11 or by lightly pushing the obstacle, for example. Although the robot 11 cannot clear away the obstacle temporarily placed on the moving path, a person can easily clear it away.

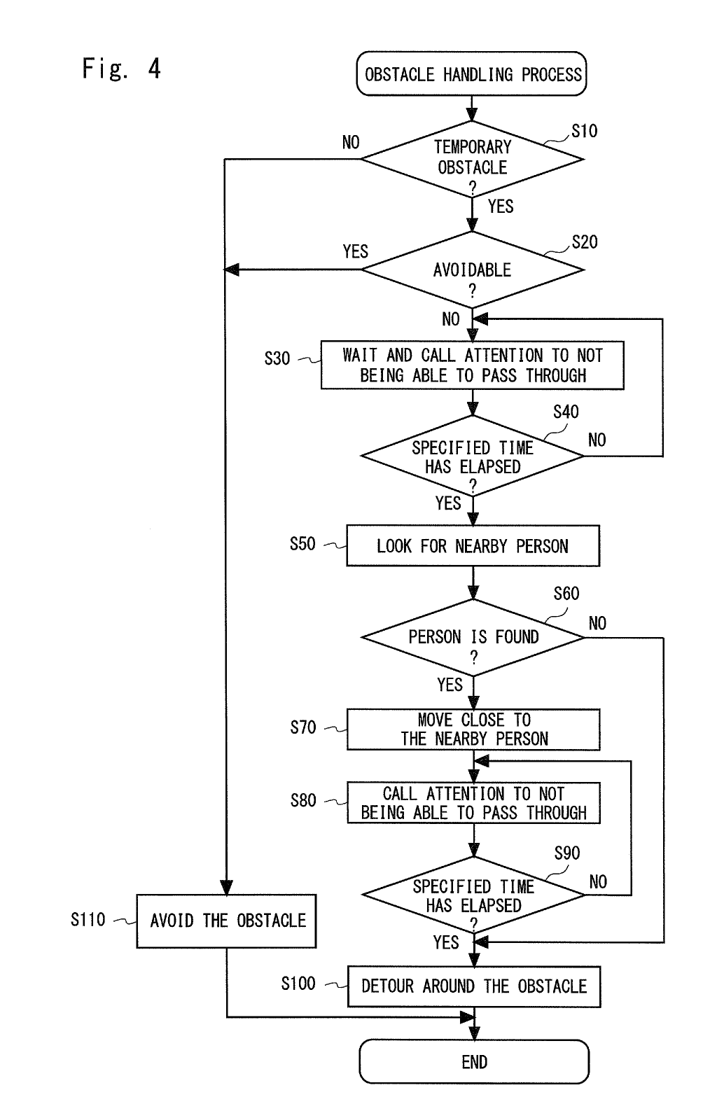

FIG. 4 is a flowchart showing a procedure of an obstacle handling process performed by the robot 11 according to the first embodiment.

First, the check unit 26 determines whether the obstacle detected on the moving path 13 and likely to interfere with the robot 11 is an obstacle not usually present, that is, whether it is the movable obstacle (Step S10).

When the check unit 26 determines that it is an obstacle that is not usually present (YES in Step S10), the control unit 27 determines whether the obstacle is avoidable, that is, whether avoiding action can be selected (Step S20). When the control unit 27 determines that the obstacle is not avoidable (NO in Step S20), it selects waiting action, and the informing device 23 informs a person nearby that it cannot go through the path and appeals to the person to clear away the obstacle (Step S30). If the obstacle is cleared away, the control unit 27 lets the robot 11 start moving again.

Then, the control unit 27 determines whether a specified period of time has elapsed with the obstacle remaining without being cleared away (Step S40). When the control unit 27 determines that a specified period of time has elapsed (YES in Step S40), it searches for a person nearby by detecting a moving object using a camera built in the robot 11, detecting a place with a human temperature using the infrared camera 28 or the non-contact thermometer 29, or detecting an aperiodic sound source using the microphone 30 (Step S50).

Then, when there is a person nearby (YES in Step S60), the control unit 27 causes the robot 11 to move close to the nearby person (Step S70), and the informing device 23 appeals to the person that it cannot go through the path and the obstacle needs to be cleared away (Step S80). When making an appeal at the position close to the nearby person, the volume or the like can be turned down. If the obstacle is cleared away, the control unit 27 lets the robot 11 start moving again.

Then, the control unit 27 determines whether a specified period of time has elapsed with the obstacle remaining without being cleared away after informing the nearby person (Step S90). When the control unit 27 determines that a specified period of time has elapsed (YES in Step S90), it makes a detour, that is, selects detouring action (Step S100).

Note that, when the check unit 26 determines that the obstacle is the one that is usually present (NO in Step S10), or when the control unit 27 determines that the obstacle is avoidable (YES in Step S20), the control unit 27 avoids the obstacle, that is, selects avoiding action (Step S110).

Further, when the control unit 27 determines that a specified period of time has not elapsed with the obstacle remaining without being cleared away (NO in Step S40 or NO in Step S90), the informing device 23 appeals again to a person around or nearby that the robot 11 cannot go through the path and the obstacle needs to be cleared away (Step S30 or Step S80).

As described above, the autonomous moving body according to the first embodiment includes a recording unit that records in advance position information of a fixed obstacle whose position does not change, a detection unit that detects an obstacle likely to interfere with the autonomous moving body when moving through a moving path, a check unit that checks whether the detected obstacle is the fixed obstacle, a control unit that determines whether to clear away the obstacle when the check unit concludes that the obstacle is not the fixed obstacle, and an informing unit that outputs a signal requesting to clear away the obstacle when the control unit determines to clear away the obstacle. It is thereby possible to prevent the degradation of the moving efficiency of the autonomous moving body even when the autonomous moving body moves through the path where the position of the obstacle changes frequently.

Further, in the autonomous moving body according to the first embodiment, the detection unit detects an obstacle around the moving path at each of a plurality of times when the autonomous moving body moves through the moving path, and when the detected obstacle is an obstacle whose position does not change, position information of the detected obstacle is recorded as position information of the fixed obstacle in the recording unit. It is thereby possible to easily prevent the degradation of the moving efficiency of the autonomous moving body without need for a person to enter information of the fixed obstacle.

Further, in the autonomous moving body according to the first embodiment, when the check unit concludes that the obstacle is not the fixed obstacle, the control unit determines whether the obstacle is avoidable, and when determining that the obstacle is avoidable, the control unit controls the autonomous moving body to move to avoid the obstacle, and when determining that the obstacle is not avoidable, the control unit controls the informing unit to output the signal. It is thereby possible to reduce the time required for waiting action and prevent the degradation of the moving efficiency of the autonomous moving body.

Further, in the autonomous moving body according to the first embodiment, when a specified period of time has elapsed with the obstacle remaining without being cleared away after the signal is output, the control unit controls the autonomous moving body to detect a person nearby, and when a person nearby is detected, the control unit controls the autonomous moving body to move toward the person and controls the informing unit to output the signal again, and when a person nearby is not detected, the control unit controls the autonomous moving body to detour around the obstacle. It is thereby possible to reduce the time required for waiting action and prevent the degradation of the moving efficiency of the autonomous moving body.

Note that, although the informing device 23 such as an informing unit, a light or a speaker is placed inside the robot 11 to output a light signal, an audio signal or the like in order to make an appeal to clear away the obstacle in the first embodiment, an informing unit may be placed inside the robot 11, and an informing device such as a light or a speaker may be placed outside the robot 11 such as a position that draws a person's attention in the moving area 12, for example, and the informing unit may output a signal requesting to clear away the obstacle, and the informing device may receive the signal and perform an informing act.

Further, although a three-dimensional map of fixed obstacles is created by comparing obstacles that have been detected by moving through or around in the area a plurality of times and setting an obstacle whose position does not change as a fixed obstacle in the first embodiment, an operator may specify a fixed obstacle among obstacles that have been detected when the robot 11 moves through or around in the moving area 12 once in the past and thereby create a three-dimensional map of fixed obstacles.

Furthermore, although obstacles that have been detected by moving through or around in the area a plurality of times are checked and an obstacle whose position does not change is recorded as the fixed obstacle in the first embodiment, when an obstacle is added to a place where there has been no obstacle and its position does not change, the obstacle may be additionally recorded as the fixed obstacle.

### Second Embodiment of the Invention

An autonomous moving body according to a second embodiment accesses a schedule management system and, when detecting a situation where people within the moving area 12 are mostly absent due to a meeting or the like, changes the moving path and limits the area to move through or around to thereby enhance the moving efficiency.

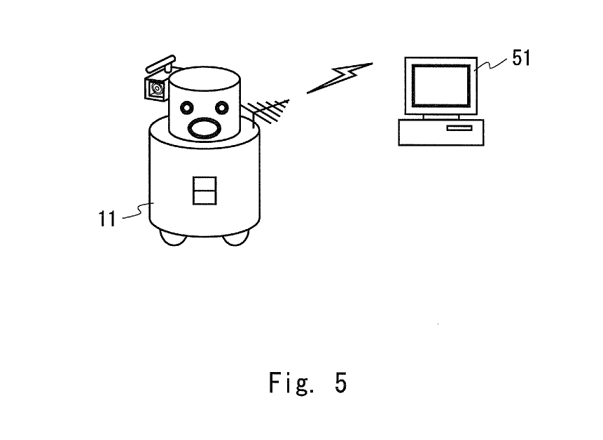

FIG. 5 is a diagram showing a relationship between the robot 11, which is the autonomous moving body according to the second embodiment, and a schedule management system 51. The robot 11 is linked with the schedule management system 51 through a network (not shown). The structure of the robot 11 is the same as the structure of the robot 11 according to the first embodiment and not redundantly illustrated.

In an office or a factory, there is a case where people are absent in units of organization such as division, department or section or in units of group such as male or female due to a meeting, a medical examination or the like, and in such a case, the robot 11 cannot provide a service even if it moves around in the area occupied by the organization or group.

In view of this, the control unit 27 of the robot 11 accesses the schedule management system in advance and checks the schedules and attendance of persons within the area where a service is to be provided in units of organization or group. When there are no or few persons to receive the service, the control unit 27 changes the moving path so as not to go to the area occupied by the organization or group to which they belong. Because some persons may not enter their schedules, the control unit 27 may determine not to go to the area when a specified percentage of people in the organization or group are absent or determine that people with the same schedule are absent and not to go to the area.

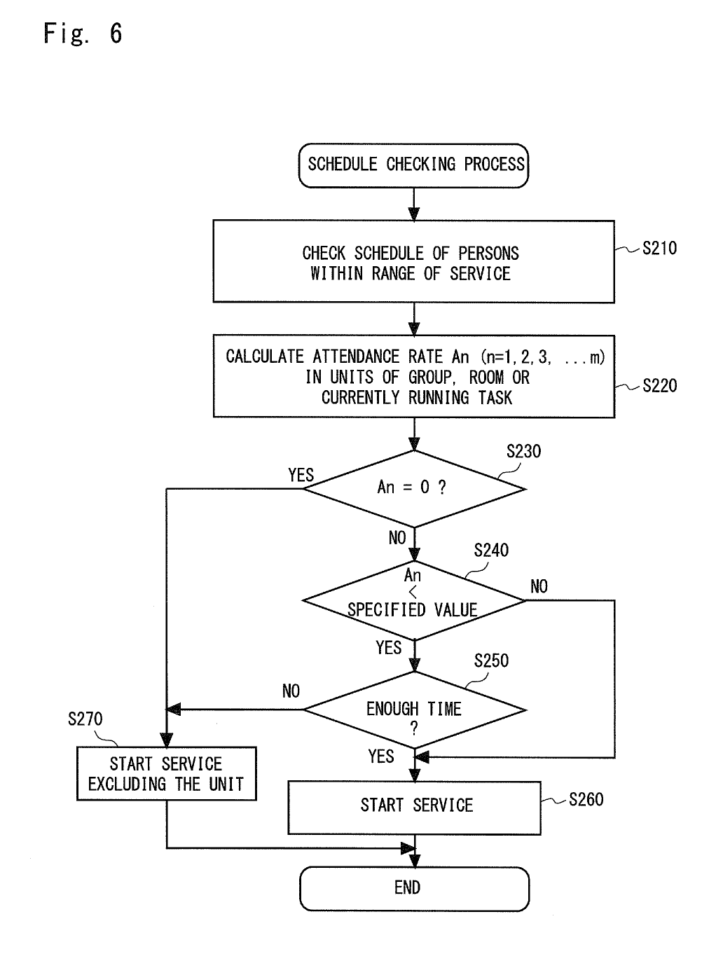

FIG. 6 is a flowchart showing a procedure of a schedule checking process performed by the robot 11 according to the second embodiment.

First, the control unit 27 accesses the schedule management system 51 through the network at regular time intervals and checks the schedules of persons within the range of service provided by the robot 11 (Step S210).

Then, an attendance rate An (n=1, 2, . . . m-1, m where n is a number corresponding to a unit such as an organization) of persons to receive the service is calculated in units of organization, group, currently running task or the like (Step S220). When the attendance rate An is a specified value or more (NO in Step S230 and NO in Step S240) and when the attendance rate An is not 0 but less than a specified value and there is enough time (NO in Step S230, YES in Step S240, and YES in Step S250), the service is started (Step S260).

On the other hand, when the attendance rate An is 0 (YES in Step S230) and when the attendance rate An is not 0 but less than a specified value and there is not enough time (NO in Step S230, YES in Step S240, and NO in Step S250), the service is provided by changing the moving path to exclude the place or area occupied by the unit such as the organization (Step S270).

Note that the autonomous moving body may enter preparation mode in a specified period of time. The autonomous moving body provides a service such as collecting dirt in active mode. On the other hand, the autonomous moving body charges itself at a charging station or stops still in preparation mode. By setting a period such as a morning assembly or lunch break as the specified period of time, the autonomous moving body enters preparation mode and stays silent when people do not want to receive the service, and therefore it does not bother people.

As described above, the autonomous moving body according to the second embodiment is to provide a service to persons around the moving path, and the control unit accesses a schedule management system and checks schedules of the persons to receive the service, calculates an attendance rate for each organization or group to which the persons belong, and changes the moving path to omit the service to the persons belonging to the organization where the attendance rate is less than a specified value. It is thereby possible to limit the moving path and prevent the degradation of the moving efficiency of the autonomous moving body.

### Third Embodiment of the Invention

An autonomous moving body according to a third embodiment searches for a person nearby using a sensor, and when nobody is present, does not go to the place or area to thereby enhance the moving efficiency.

The structure of the robot 11 is the same as the structure of the robot 11 according to the first embodiment and not redundantly illustrated.

The robot 11 searches for a person nearby by looking for a moving object using a camera, looking for a place with a human temperature using the infrared camera 28 or the non-contact thermometer 29, or looking for an aperiodic sound source using the microphone 30, and when nobody is present, does not go to the place or area.

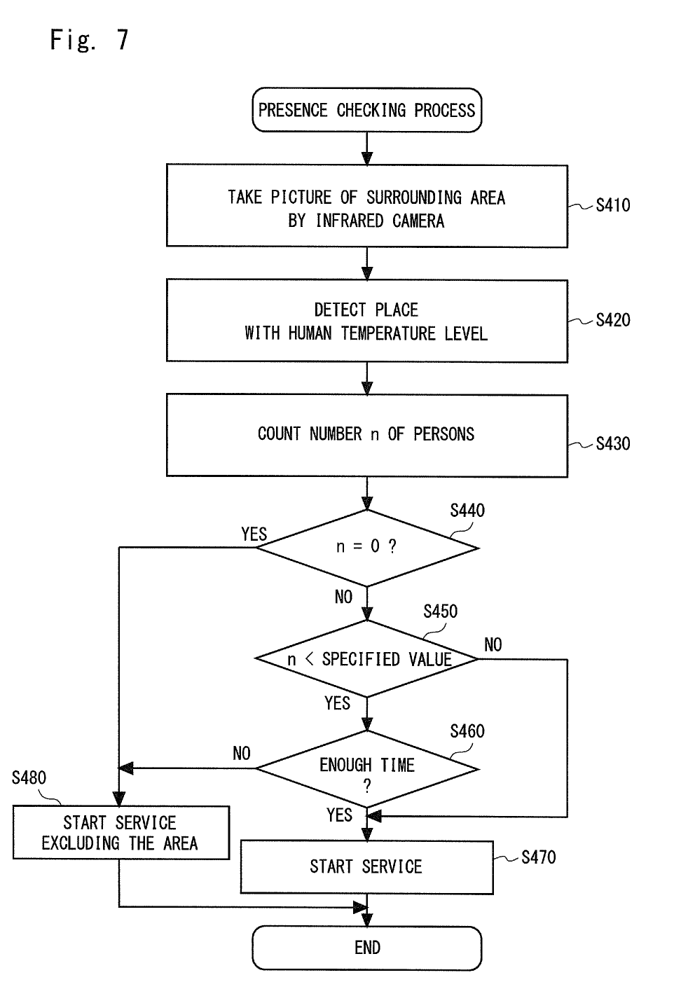

FIG. 7 is a flowchart showing a procedure of a presence checking process performed by the robot 11 according to the third embodiment.

The infrared camera 28 takes a picture of the surrounding area at regular time intervals (Step S410) and detects a place at a human temperature level (Step S420).

The control unit 27 counts the number of detected objects, which is, the number n of persons (Step S430). When the number n of persons is a specified value or more (NO in Step S440 and NO in Step S450) and when the number n of persons is not 0 but less than a specified value and there is enough time (NO in Step S440, YES in Step S450, and YES in Step S460), the service is started (Step S470).

On the other hand, when the number n of persons is 0 (YES in Step S440) and when the number n of persons is not 0 but less than a specified value and there is not enough time (NO in Step S440, YES in Step S450, and NO in Step S460), the service is started excluding the place or area (Step S480).

Note that the autonomous moving body may enter preparation mode when it determines that nobody is present in a specified area where a service is to be provided, such as in early morning or late night. When there is no person in a specified area, there is nothing to receive the service provided by the autonomous moving body. The autonomous moving body enters preparation mode and thereby does not consume unnecessary energy and can work efficiently.

As described above, the autonomous moving body according to the third embodiment is to provide a service to persons around the moving path, and the control unit calculates an attendance rate of the persons to receive the service for each area using a senor, and changes the moving path to omit the service to the persons belonging to the area where the attendance rate is less than a specified value. It is thereby possible to limit the moving path and prevent the degradation of the moving efficiency of the autonomous moving body.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An autonomous moving body comprising:
a recording unit that records in advance position information of a fixed obstacle whose position does not change;
a detection unit that detects an obstacle likely to interfere with the autonomous moving body when moving through a moving path;
a check unit that checks whether the detected obstacle is the fixed obstacle;
a control unit that determines whether to clear away the obstacle when the check unit concludes that the obstacle is not the fixed obstacle; and
an informing unit that outputs a signal requesting to clear away the obstacle when the control unit determines to clear away the obstacle.

2. The autonomous moving body according to claim 1, wherein
the detection unit detects an obstacle around the moving path at each of a plurality of times when the autonomous moving body moves through the moving path, and
when the detected obstacle is an obstacle whose position does not change, position information of the detected obstacle is recorded as position information of the fixed obstacle in the recording unit.

3. The autonomous moving body according to claim 1, wherein
when the check unit concludes that the obstacle is not the fixed obstacle, the control unit determines whether the obstacle is avoidable, and
when determining that the obstacle is avoidable, the control unit controls the autonomous moving body to move to avoid the obstacle, and
when determining that the obstacle is not avoidable, the control unit controls the informing unit to output the signal.

4. The autonomous moving body according to claim 1, wherein
when a specified period of time has elapsed with the obstacle remaining without being cleared away after the signal is output, the control unit controls the autonomous moving body to detect a person nearby, and
when a person nearby is detected, the control unit controls the autonomous moving body to move toward the person and controls the informing unit to output the signal again, and
when a person nearby is not detected, the control unit controls the autonomous moving body to detour around the obstacle.

5. The autonomous moving body according to claim 1, wherein
the autonomous moving body is to provide a service to persons around the moving path, and
the control unit accesses a schedule management system and checks schedules of the persons to receive the service, calculates an attendance rate for each organization or group to which the persons belong, and changes the moving path to omit the service to the persons belonging to the organization or group where the attendance rate is less than a specified value.

6. The autonomous moving body according to claim 1, wherein
the autonomous moving body is to provide a service to persons around the moving path, and
the control unit calculates an attendance rate of the persons to receive the service for each area using a senor, and changes the moving path to omit the service to the persons belonging to the area where the attendance rate is less than a specified value.

7. An obstacle sensing method for an autonomous moving body, comprising:
a recording step of recording in advance position information of a fixed obstacle whose position does not change;
a detection step of detecting an obstacle likely to interfere with the autonomous moving body when moving through a moving path;
a check step of checking whether the detected obstacle is the fixed obstacle; and
a determination step of determining that the obstacle is a movable obstacle whose position changes or a movable obstacle placed temporarily when the obstacle is not the fixed obstacle.

8. The obstacle sensing method for an autonomous moving body according to claim 7, wherein the recording step includes:
a peripheral detection step of detecting an obstacle around the moving path at each of a plurality of times when the autonomous moving body moves through the moving path; and
a fixed obstacle recording step of recording position information of the obstacle detected in the peripheral detection step and whose position does not change as position information of the fixed obstacle.

9. An obstacle avoiding method for an autonomous moving body, comprising:
an obstacle determination step of determining that the obstacle likely to interfere with the autonomous moving body as the movable obstacle using the obstacle sensing method for an autonomous moving body according to claim 7;
an avoidance determination step of determining whether the movable obstacle is avoidable;
an avoiding step of moving to avoid the movable obstacle when determining that the movable obstacle is avoidable; and
a signal output step of outputting a signal requesting to clear away the movable obstacle when determining that the movable obstacle is not avoidable.
